(19) United States
(12) Patent Application Publication
(10) Pub. No.: US 2007/0018556 A1
(43) Pub. Date: Jan. 25, 2007

(54) Color picture tube

(75) Inventors: Tadahiro Kojima, Ibaraki-shi (JP); Takashi Murai, Ibaraki-shi (JP); Takeshi Nakayama, Ibaraki-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/446,407

(22) Filed: Jun. 2, 2006

(30) Foreign Application Priority Data
Jul. 20, 2005 (JP) 2005-210521

(51) Int. Cl. H01J 29/86; H01J 29/92

(52) U.S. Cl. 313/477 R

(57) ABSTRACT

A radius of curvature of an arc passing through three points on an outer surface of a panel, which respectively correspond to a pair of diagonal axis ends on one diagonal axis of a phosphor screen and a center of the phosphor screen, is 10,000 mm or more. A shadow mask is made of an aluminum killed material. Assuming that a thickness of the panel is Td at the diagonal axis end of the phosphor screen, Tmd at an intermediate point between the diagonal axis end and the center, Th at a major axis end of the phosphor screen, and Tmh at an intermediate point between the major axis end and the center, 0.5 ≦Tmd/Td≦0.62, and 0.65≦Tmh/Th≦0.80 are satisfied. Because of this, an inexpensive color picture tube can be provided, in which the visibility is excellent, the degradation in color purity caused by doming is suppressed, and the formability of the shadow mask is enhanced.

### BACKGROUND OF THE INVENTION

1. Field of the Invention

The present invention relates to a color picture tube.

2. Description of Related Art

In general, as shown in FIG. 7, a color picture tube includes a vacuum envelope 9 composed of a panel 3 in which a skirt portion 2 is provided on the periphery of a substantially rectangular useful portion 1, and a funnel 4 in a funnel shape connected to the skirt portion 2. On an inner surface of the useful portion 1 of the panel 3, a phosphor screen 5 is formed in a substantially rectangular shape, which is composed of black non-light-emitting material layers and three-color phosphor layers in a stripe or dot shape provided in regions where the black non-light-emitting material layers are not formed. A shadow mask 7 is placed so as to be opposed to the phosphor screen 5, which has a perforated region in a substantially rectangular shape where a number of electron beam passage apertures are arranged in vertical and horizontal directions. The shadow mask 7 is held on a mask frame 8 in a substantially rectangular frame shape. In a neck 4a of the funnel 4, an electron gun 11 emitting three electron beams 6B, 6G, and 6R is provided. On an inner side of a large diameter portion of the funnel 4, an inner shield 10 shielding the three electron beams 6B, 6G, 6R from an external magnetic field is attached to the mask frame 8. The three electron beams 6B, 6G, 6R emitted from the electron gun 11 are deflected by a magnetic field generated by a deflection apparatus 12 mounted on an outer side of the funnel 4, and allowed to scan the phosphor screen 5 via the shadow mask 7 in horizontal and vertical directions, whereby a color image is displayed.

In the color picture tube, increased thickness of the center of the useful portion 1 of the panel 3 causes not only the degradation in image characteristics such as the decrease in brightness, but also the increase in weight of the panel 3 and the like, which is disadvantageous in terms of cost. On the other hand, decreased thickness can enhance the brightness and the like, which is advantageous for image characteristics; however, it degrades implosion-protection characteristics and increases the leakage of an X-ray. Thus, the thickness of the center of the useful portion 1 of the panel 3 generally is in a range of about 10 mm to 20 mm.

In general, in order to display an image without color displacement on the phosphor screen 5 of the color picture tube, it is necessary that the three electron beams 6B, 6G, 6R having passed through the electron beam passage apertures formed in the shadow mask 7 should land correctly on the three-color phosphor layers of the phosphor screen 5, respectively.

For this purpose, the relationship between the panel 3 and the shadow mask 7, above all, an interval (q value) between the inner surface of the useful portion 1 of the panel 3 and the perforated region of the shadow mask 7 needs to be kept within a predetermined allowable range.

In the shadow mask type color picture tube, about ⅓ of the total electron beams emitted from the electron gun 11 passes through the electron beam passage apertures of the shadow mask 7 to reach the phosphor screen 5, and the remaining electron beams strike the shadow mask 7 to be converted into thermal energy. Therefore, the shadow mask 7 is heated, and expands thermally in accordance with the coefficient of thermal expansion of the material thereof. This thermal expansion deforms the shadow mask 7 so that it swells toward the phosphor screen 5 side. Consequently, when the q value of the interval between the inner surface of the useful portion 1 of the panel 3 and the shadow mask 7 falls outside an allowable range, electron beams do not land on desired phosphor layers and cause so-called mislanding, which degrades color purity.

The magnitude of a landing positional shift of the electron beams caused by the thermal expansion of the shadow mask 7 varies largely depending upon the brightness of an image pattern to be displayed, the duration time of the pattern, and the like. In particular, when displaying a high-brightness image pattern locally, only a part of the perforated region of the shadow mask 7 is heated to cause local doming, and a local landing positional shift is caused within a short period of time. In the local doming, the amount of a landing positional shift is large, so that the degradation in color purity is large. It is known that, for example, in the case where a white display is performed in a region 20 including an intermediate point Pmh in a major axis direction between a center Pc of the phosphor screen 5 and a major axis (X-axis) end Ph, and a black display is performed in the other regions as shown in FIG. 8, and in the case where a white display is performed in a region 21 including an intermediate point Pmd in a diagonal axis direction between the center Pc of the phosphor screen 5 and a diagonal axis (D-axis) end Pd, and a black display is performed in the other regions as shown in FIG. 9, large local doming is likely to occur, and color purity is most likely to be degraded.

The reason for the above is considered as follows. As described above, when a white display is performed locally, only a region of the shadow mask 7 corresponding to the region where the white display is performed is heated locally, with the result that local doming occurs. In the regions of the shadow mask 7 corresponding to the regions 20, 21 where the white display is performed in FIGS. 8 and 9, the movement amount in the tube axis direction of the shadow mask 7 caused by doming is large and the incident angle of electron beams with respect to the shadow mask 7 is large, with the result that the color purity is degraded most remarkably.

Recently, in order to enhance the visibility of the color picture tube, there is a demand that the radius of curvature of the outer surface of the useful portion 1 of the panel 3 be increased so as to bring the outer surface close to a flat surface. In this case, in terms of the strength with respect to the atmospheric pressure of the vacuum envelope 9 and the visibility, the radius of curvature of the inner surface of the useful portion 1 also needs to be increased.

In order to allow the electron beams to land appropriately at desired positions on the phosphor screen 5, it is necessary to set appropriately the q value of the interval between the inner surface of the useful portion 1 where the phosphor screen 5 is formed and the perforated region of the shadow mask 7. Therefore, the radius of curvature of the perforated region of the shadow mask 7 also needs to be increased in accordance with the increase in the radius of curvature of the inner surface of the useful portion 1.

However, when the radius of curvature of the perforated region of the shadow mask 7 is increased, the doming amount also increases. Therefore, the amount of a landing positional shift of electron beams also increases, and the color purity is degraded remarkably.

Consequently, in a color picture tube in which the outer surface of the useful portion 1 of the panel 3 is substantially flat, in order to suppress doming, an alloy containing iron and nickel as main components, having a low coefficient of thermal expansion, is used generally as a material for the shadow mask 7. For example, an iron-nickel alloy such as 36 Ni Invar (registered trademark) alloy is used. Such an alloy suffers from high cost, although it has a coefficient of thermal expansion of 1 to 2×10⁻⁶ at 0° C. to 100° C., and is effective for suppressing doming. Furthermore, the iron-nickel alloy has large elasticity after annealing, so that it is difficult to form a curved surface from such an alloy by forming and to obtain a desired curved surface. Even if the iron-nickel alloy is annealed, for example, at a high temperature of 900° C., the yield point strength is about 28×10⁷ N/m². Thus, it is necessary to treat the alloy at a considerably high temperature in order to set the yield point strength to be 20×10⁷ N/m² or less at which forming generally is considered to be easy. Particularly, in a color picture tube in which the outer surface of the panel 3 is flat, the radius of curvature of the shadow mask 7 generally is large, so that forming is further difficult.

In the case where forming is insufficient, and undesired stress remains in the shadow mask 7 after forming, the residual stress changes the shape of the shadow mask 7 in the course of production of the color picture tube, which leads to the landing positional shift of the electron beams, resulting in the significant degradation in color purity.

On the other hand, with a material (e.g., an aluminum killed material) containing iron with high purity as a main component, the yield point strength can be set to be 20×10⁷ N/m² or less by annealing at about 800° C., so that forming is very easy. Thus, it is not necessary to keep the die temperature high in the course of forming, which is required in an Invar (registered trademark) alloy, and the productivity also is satisfactory. A material unit price also is low.

However, the aluminum killed material has a large coefficient of thermal expansion (i.e., about 12×10⁻⁶ at 0° C. to 100° C.), which is disadvantageous for doming. Particularly, in the case of applying such a material to a color picture tube in which the outer surface of the useful portion 1 of the panel 3 is substantially flat, the color purity is degraded significantly, which causes a serious problem.

JP 2004-31305 A describes a color picture tube in which a shadow mask made of a material containing iron as a main component is used, and the ratio of the respective thicknesses at the center, diagonal axis end, major axis end, and minor axis end of a useful portion of a panel is set, whereby the degradation in image quality caused by doming is suppressed.

However, JP 2004-31305 A does not consider a portion where local doming generally is likely to occur, such as an intermediate point between the center and the major axis end of the useful portion of the panel, so that the effect of suppressing doming is not obtained sufficiently. JP 2004-31305 A also has a problem that the thickness of the panel becomes large so that the weight is increased.

### SUMMARY OF THE INVENTION

The present invention has been achieved in view of the above conventional problems, and its object is to provide a color picture tube in which the visibility and the formability of a shadow mask are enhanced, and the degradation in color purity caused by doming is suppressed.

A color picture tube according to the present invention includes: a panel with a substantially rectangular phosphor screen formed on an inner surface; a funnel connected to the panel; a shadow mask opposed to the phosphor screen; and an electron gun provided in a neck of the funnel.

A radius of curvature of an arc passing through three points on an outer surface of the panel, which respectively correspond to a pair of diagonal axis ends on one diagonal axis of the phosphor screen and a center of the phosphor screen, is 10,000 mm or more.

The shadow mask is made of an aluminum killed material (which may be called low carbon steel).

Furthermore, assuming that a thickness of the panel is Td at the diagonal axis end of the phosphor screen, Tmd at an intermediate point between the diagonal axis end and the center, Th at a major axis end of the phosphor screen, and Tmh at an intermediate point between the major axis end and the center, 0.5≦Tmd/Td≦0.62, and 0.65≦Tmh/Th≦0.80 are satisfied.

### BRIEF DESCRIPTION OF THE DRAWINGS

FIG. 1 is a perspective view showing a portion, in which a phosphor screen is formed, of a panel of a color picture tube according to one embodiment of the present invention.

FIG. 2 is a perspective view showing an inner surface of the panel, in which the phosphor screen is formed, of the color picture tube according to one embodiment of the present invention.

FIG. 3 is a perspective view showing a perforated region of the shadow mask of the color picture tube according to one embodiment of the present invention.

FIG. 4 is a diagram showing a relationship between a panel thickness ratio Tmd/Td and a beam movement amount in a diagonal axis direction.

FIG. 5 is a diagram showing a relationship between a panel thickness ratio Tmh/Th and a beam movement amount in a major axis direction.

FIG. 6 is a diagram showing a relationship between a panel thickness ratio Tmv/Tv and a beam movement amount in a minor axis direction.

FIG. 7 is a cross-sectional view showing a schematic configuration of a color picture tube.

FIG. 8 is a diagram showing an exemplary display pattern in which local doming of a shadow mask is likely to occur.

FIG. 9 is a diagram showing another exemplary display pattern in which local doming of a shadow mask is likely to occur.

### DETAILED DESCRIPTION OF THE INVENTION

According to the present invention, the outer surface of a panel is substantially flat, so that the visibility is excellent. Furthermore, a shadow mask is made of an aluminum killed material, so that it is inexpensive and has excellent formability.

Furthermore, by defining the ratio in thickness of the panel in a diagonal axis direction and a major axis direction, even if the visibility and the formability of the shadow mask are enhanced, the degradation in color purity caused by doming can be suppressed.

Hereinafter, the present invention will be described in detail with reference to the drawings.

### Embodiment 1

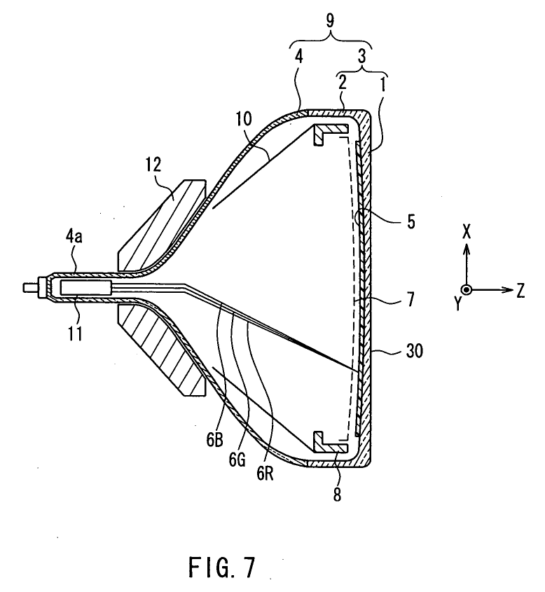

FIG. 7 is a cross-sectional view of a color picture tube according to one embodiment of the present invention. The color picture tube includes a vacuum envelope 9 composed of a panel 3 in which a skirt portion 2 is provided on the periphery of a useful portion 1 in a substantially rectangular shape, and a funnel 4 in a funnel shape connected to the skirt portion 2. On an inner surface of the useful portion 1 of the panel 3, a phosphor screen 5 is formed in a substantially rectangular shape, which is composed of black non-light-emitting material layers and three-color phosphor layers in a stripe or dot shape provided in regions where the black non-light-emitting material layers are not formed. A shadow mask 7, having a perforated region in a substantially rectangular shape in which a number of electron beam passage apertures are arranged in vertical and horizontal directions, is placed so as to be opposed to the phosphor screen 5. The shadow mask 7 is held on a mask frame 8 in a substantially rectangular frame shape. In a neck 4a of the funnel 4, an electron gun 11 emitting three electron beams 6B, 6G, and 6R is provided. On an inner side of a large diameter portion of the funnel 4, an inner shield 10 shielding the three electron beams 6B, 6G, 6R from an external magnetic field is attached to the mask frame 8. The three electron beams 6B, 6G, 6R emitted from the electron gun 11 are deflected by a magnetic field generated by a deflection apparatus 12 mounted on the outer side of the funnel 4, and allowed to scan the phosphor screen 5 via the shadow mask 7 in horizontal and vertical directions, whereby a color image is displayed.

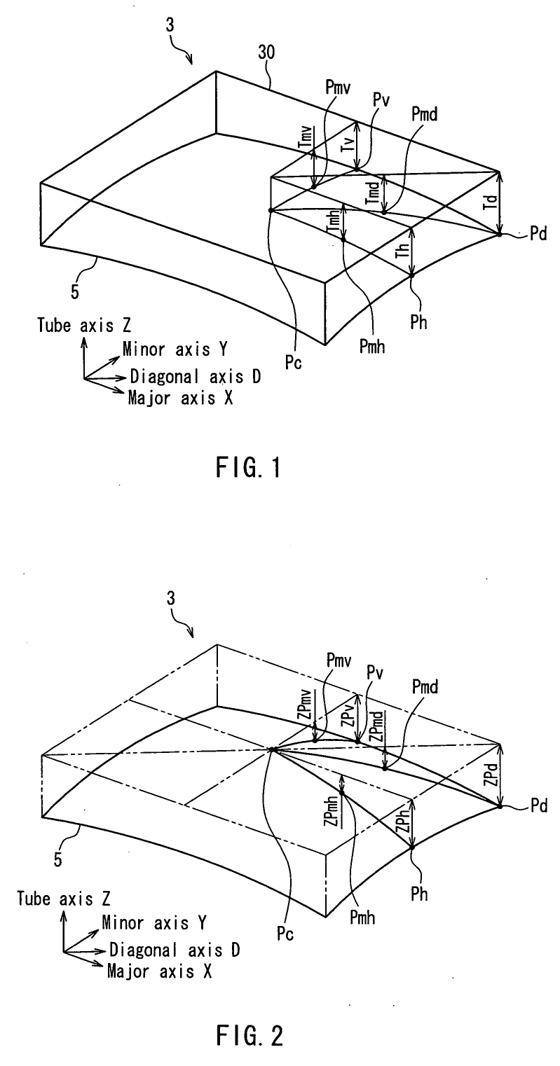

FIG. 1 is a perspective view showing only a portion of the panel 3, in which the phosphor screen 5 is formed. As shown, the phosphor screen 5 is formed in a substantially rectangular shape, when seen from a tube axis direction, on an inner surface of the panel 3 formed in a predetermined curved surface. Reference numeral 30 denotes an outer surface of the panel 3.

For convenience of the following description, an axis that is orthogonal to a tube axis (Z-axis) of the color picture tube and parallel to a long side of the phosphor screen 5 is referred to as a major axis (X-axis), and an axis that is orthogonal to the tube axis and parallel to a short side of the phosphor screen 5 is referred to as a minor axis (Y-axis).

Furthermore, a point on the phosphor screen 5 that the tube axis crosses is referred to as a center Pc, a position at which a peripheral edge of the phosphor screen 5 crosses a plane including the major axis and the tube axis is referred to as a major axis end Ph, a position at which the peripheral edge of the phosphor screen 5 crosses a plane including the minor axis and the tube axis is referred to as a minor axis end Pv, a position at which the long side and short side of the phosphor screen 5 cross each other is referred to as a diagonal axis end Pd, and an axis in a direction connecting a pair of diagonal axis ends Pd at positions symmetrical with respect to the tube axis is referred to as a diagonal axis D. Furthermore, a point on the phosphor screen 5 at an intermediate position between the center Pc and the major axis end Ph is referred to as a major axis intermediate point Pmh, a point on the phosphor screen 5 at an intermediate position between the center Pc and the minor axis end Pv is referred to as a minor axis intermediate point Pmv, and a point on the phosphor screen 5 at an intermediate position between the center Pc and the diagonal axis end Pd is referred to as a diagonal axis intermediate point Pmd. Herein, the distance in the major axis direction between the center Pc and the major axis intermediate point Pmh is half the distance in the major axis direction between the center Pc and the major axis end Ph. The distance in the minor axis direction between the center Pc and the minor axis intermediate point Pmv is half the distance in the minor axis direction between the center Pc and the minor axis end Pv. The distance in the diagonal axis direction between the center Pc and the diagonal axis intermediate point Pmd is half the distance in the diagonal axis direction between the center Pc and the diagonal axis end Pd.

Furthermore, the thicknesses of the panel 3 in the tube axis direction at respective positions: the major axis end Ph, the major axis intermediate point Pmh, the minor axis end Pv, the minor axis intermediate point Pmv, the diagonal axis end Pd, and the diagonal axis intermediate point Pmd are designated as Th, Tmh, Tv, Tmv, Td, and Tmd in this order.

FIG. 2 is a perspective view showing only a region, in which the phosphor screen 5 is formed, of the inner surface of the panel 3. The displacement amounts (sagging amounts) of the inner surface of the panel 3 in the tube axis direction at respective positions: the major axis end Ph, the major axis intermediate point Pmh, the minor axis end Pv, the minor axis intermediate point Pmv, the diagonal axis end Pd, and the diagonal axis intermediate point Pmd, with respect to the center Pc, are designated as ZPh, ZPmh, ZPv, ZPmv, ZPd, and ZPmd in this order.

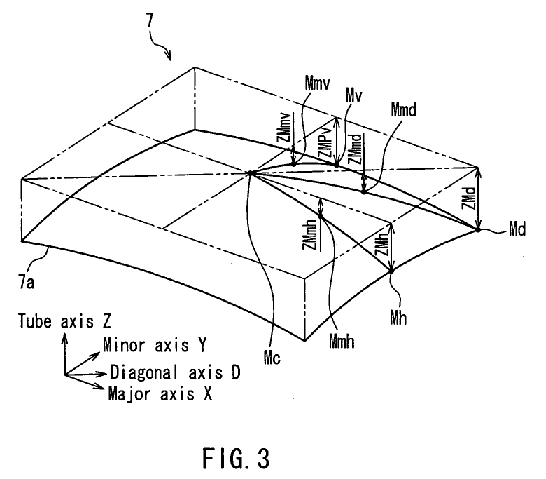

FIG. 3 is a perspective view showing only a perforated region 7a of the shadow mask 7 in which electron beam passage apertures are formed. As shown, the perforated region 7a has a substantially rectangular shape when seen from the tube axis direction. Points on the perforated region 7a corresponding to the center Pc, the major axis end Ph, the major axis intermediate point Pmh, the minor axis end Pv, the minor axis intermediate point Pmv, the diagonal axis end Pd, and the diagonal axis intermediate point Pmd of the phosphor screen 5 are designated as a center Mc, a major axis end Mh, a major axis intermediate point Mmh, a minor axis end Mv, a minor axis intermediate point Mmv, a diagonal axis end Md, and a diagonal axis intermediate point Mmd in this order. Furthermore, the displacement amounts (sagging amounts) of the perforated region 7a in the tube axis direction at respective positions: the major axis end Mh, the major axis intermediate point Mmh, the minor axis end Mv, the minor axis intermediate point Mmv, the diagonal axis end Md, and the diagonal axis intermediate point Mmd, with respect to the center Mc, are designated as ZMh, ZMmh, ZMv, ZMmv, ZMd, and ZMmd in this order.

In the present embodiment, in order to enhance the visibility, a region corresponding to the phosphor screen 5 of the outer surface 30 of the panel 3 is substantially flat. More specifically, the radius of curvature of a virtual arc passing through three points (hereinafter, referred to as a “radius of curvature in a diagonal axis direction”) on the outer surface 30 of the panel 3, which respectively correspond to a pair of diagonal axis ends Pd on one diagonal axis among two diagonal axes orthogonal to the tube axis and the center Pc, is 10,000 mm or more. Herein, points on the outer surface 30 that respectively “correspond to” the diagonal axis ends Pd and the center Pc refer to the points where straight lines parallel to the tube axis and passing through the diagonal axis ends Pd and the center Pc respectively cross the outer surface 30.

When the radius of curvature of the outer surface 30 of the useful portion 1 of the panel 3 is increased so as to enhance the visibility of the color picture tube, it also is necessary to increase the radius of curvature of the inner surface of the useful portion 1 in terms of the strength with respect to the atmospheric pressure of the vacuum envelope 9 and the visibility. In this case, in order to allow electron beams to land appropriately at desired positions of the phosphor screen 5 formed on the inner surface of the useful portion 1, and display an image without color displacement, it also is necessary to increase the radius of curvature of the perforated region 7a of the shadow mask 7.

When the radius of curvature of the perforated region 7a of the shadow mask 7 is increased, it generally becomes difficult to form the curved surface of the perforated region 7a. In the present invention, an aluminum killed material that contains 95% or more of iron is used as a material for the shadow mask 7. Consequently, the formability of the curved surface can be enhanced remarkably at low cost.

However, since the coefficient of thermal expansion of the aluminum killed material is large, when an image pattern with a high brightness is displayed locally, local doming occurs, and the amount of a local landing positional shift of electron beams becomes large within a short period of time.

As measures for the above, it is considered to decrease the radius of curvature of the perforated region 7a of the shadow mask 7, and accordingly minimize the radius of curvature of the inner surface of the useful portion 1 of the panel 3. However, in this case, due to the accompanying increase in thickness of the periphery of the panel 3, there arise the following problems: the panel 3 cracks due to the thermal stress in the course of production, the brightness is degraded on the periphery of the screen, and the weight increases.

The present invention solves the above-mentioned problems. One example thereof will be described using a color picture tube (hereinafter, referred to as an “example”) with a diagonal size of 68 cm, an aspect ratio of 4:3, and a radius of curvature of 20,000 mm in the diagonal axis direction of the outer surface 30 of the useful portion 1 of the panel 3.

The shadow mask 7 of the color picture tube according to the present example is made of an aluminum killed material composed of iron with high purity having a coefficient of thermal expansion of 12×10⁻⁶ at 0 to 100° C. Thus, even when the radius of curvature of the perforated region 7a is increased in accordance with the outer surface 30 of the panel 3 flattened sufficiently as described above, sufficient formability can be ensured at low cost.

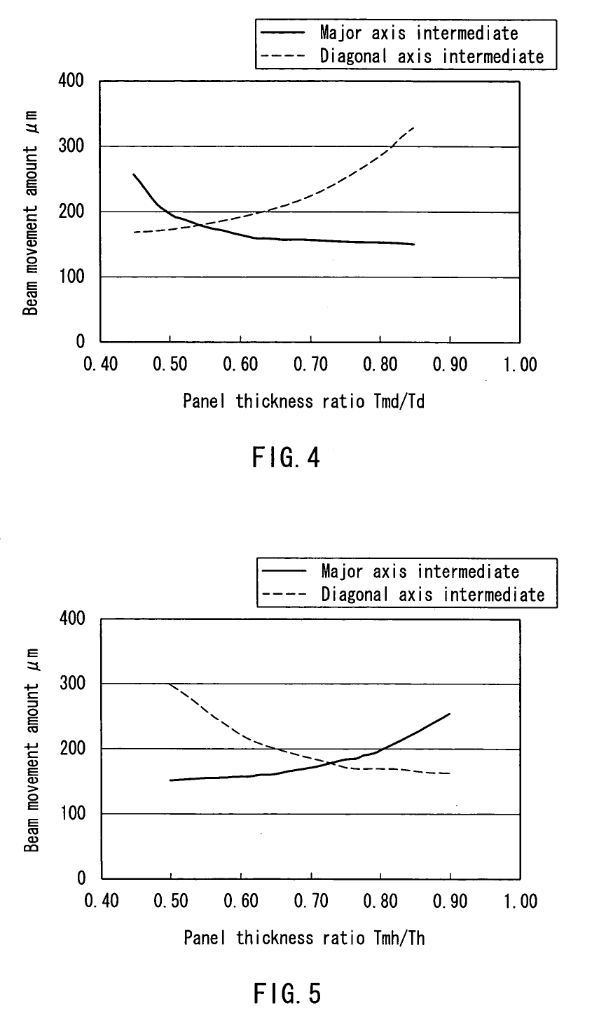

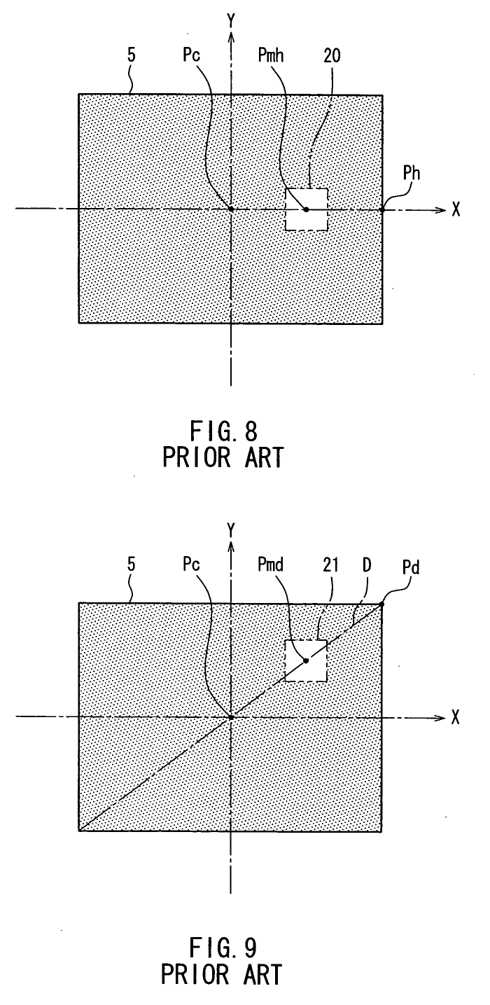

The relationship between the thickness ratio Tmd/Td and the amount of a landing positional shift of electron beams (“beam movement amount”) was obtained under the condition of setting the thickness Td of the panel 3 at the diagonal axis end Pd to be constant, and changing the thickness Tmd of the panel 3 at the diagonal axis intermediate point Pmd. Herein, the beam movement amount refers to the difference between the position on the phosphor screen 5 at which an electron beam is supposed to land, and the position at which the electron beam actually has landed due to doming of the shadow mask 7. The measurement was performed with respect to two display patterns: the case where a white display was performed only in a region 20 including the major axis intermediate point Pmh and a black display was performed in the other regions (“major axis intermediate”) as shown in FIG. 8, and the case where a white display was performed only in a region 21 including the diagonal axis intermediate point Pmd and a black display was performed in the other regions (“diagonal axis intermediate”) as shown in FIG. 9. FIG. 4 shows the results.

Furthermore, the relationship between the thickness ratio Tmh/Th and the amount of a landing positional shift of electron beams (“beam movement amount”) was obtained under the condition of setting the thickness Th of the panel 3 at the major axis end Ph to be constant, and changing the thickness Tmh of the panel 3 at the major axis intermediate point Pmh. In the same way as in FIG. 4, the measurement was performed with respect to two display patterns: the case where a white display was performed only in the region 20 including the major axis intermediate point Pmh and a black display was performed in the other regions (“major axis intermediate”) as shown in FIG. 8, and the case where a white display was performed only in the region 21 including the diagonal axis intermediate point Pmd and a black display was performed in the other regions (“diagonal axis intermediate”) as shown in FIG. 9. FIG. 5 shows the results.

In FIG. 4, when the thickness ratio Tmd/Td is decreased, the sagging amount ZPmd at the diagonal axis intermediate point Pmd of the inner surface of the panel 3 shown in FIG. 2 decreases, and the sagging amount ZMmd at the diagonal axis intermediate point Mmd of the shadow mask 7 shown in FIG. 3 also decreases. Therefore, in the shadow mask 7, the difference between the sagging amount ZMmd at the diagonal axis intermediate point Mmd and the sagging amount ZMmh at the major axis intermediate point Mmh decreases, and the radius of curvature at the major axis intermediate point Mmh increases. Consequently, in the case where a white display is performed only in the region 20 including the major axis intermediate point Pmh as shown in FIG. 8, the beam movement amount increases.

In contrast, when the thickness ratio Tmd/Td is increased, the sagging amount ZPmd at the diagonal axis intermediate point Pmd of the inner surface of the panel 3 shown in FIG. 2 increases, and the sagging amount ZMmd at the diagonal axis intermediate point Mmd of the shadow mask 7 shown in FIG. 3 also increases. Therefore, in the shadow mask 7, the difference between the sagging amount ZMmd at the diagonal axis intermediate point Mmd and the sagging amount ZMmh at the major axis intermediate point Mmh increases, and the radius of curvature at the major axis intermediate point Mmh decreases. Consequently, in the case where a white display is performed only in the region 20 including the major axis intermediate point Pmh as shown in FIG. 8, the beam movement amount decreases.

However, when the thickness ratio Tmd/Td is increased, the radius of curvature at the diagonal axis intermediate point Mmd of the shadow mask 7 increases. Therefore, in the case where a white display is performed only in the region 21 including the diagonal axis intermediate point Pmd as shown in FIG. 9, the beam movement amount increases as shown in FIG. 4.

Furthermore, in FIG. 5, when the thickness ratio Tmh/Th is increased, the sagging amount ZPmh at the major axis intermediate point Pmh of the inner surface of the panel 3 shown in FIG. 2 increases, and the sagging amount ZMmh at the major axis intermediate point Mmh of the shadow mask 7 shown in FIG. 3 also increases. Therefore, the radius of curvature at the major axis intermediate point Mmh increases. Consequently, in the case where a white display is performed only in the region 20 including the major axis intermediate point Pmh as shown in FIG. 8, the beam movement amount increases.

In contrast, when the thickness ratio Tmh/Th is decreased, the sagging amount ZPmh at the major axis intermediate point Pmh of the inner surface of the panel 3 shown in FIG. 2 decreases, and the sagging amount ZMmh at the major axis intermediate point Mmh of the shadow mask 7 shown in FIG. 3 also decreases. Therefore, the radius of curvature at the major axis intermediate point Mmh decreases. Consequently, in the case where a white display is performed only in the region 20 including the major axis intermediate point Pmh as shown in FIG. 8, the beam movement amount decreases.

However, when the thickness ratio Tmh/Th is decreased, the radius of curvature at the diagonal axis intermediate point Mmd of the shadow mask 7 increases. Therefore, in the case of performing a white display only in the region 21 including the diagonal axis intermediate point Pmd as shown in FIG. 9, the beam movement amount increases as shown in FIG. 5.

In the case of satisfying 0.5≦Tmd/Td≦0.62 from FIG. 4, and satisfying 0.65≦Tmh/Th≦0.80 from FIG. 5, the beam movement amount becomes 200 μm or less, which generally is considered not to cause a problem of visibility. Furthermore, in the case where it is necessary to reduce the beam movement amount, the thickness Td of the panel 3 at the diagonal axis end Pd and the thickness Th of the panel 3 at the major axis end Ph may be increased.

### Embodiment 2

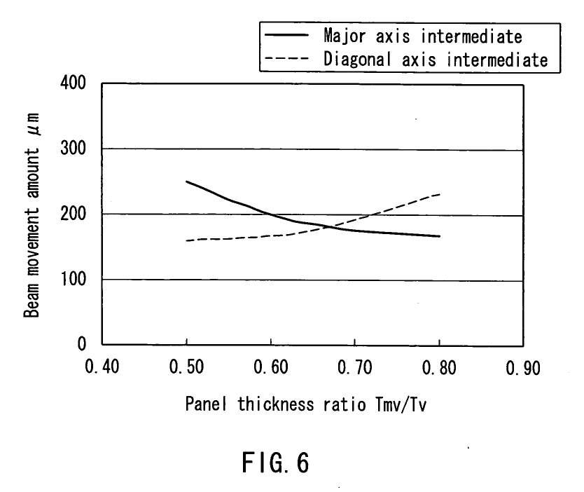

In the example described in Embodiment 1, the relationship between the thickness ratio Tmv/Tv and the amount of a landing positional shift of electron beams (“beam movement amount”) was obtained under the condition of setting the thickness Tv of the panel 3 at the minor axis end Pv of the phosphor screen 5 to be constant, and changing the thickness Tmv of the panel 3 at the minor axis intermediate point Pmv. In the same way as in FIG. 4, the measurement was performed with respect to two display patterns: the case where a white display was performed only in the region 20 including the major axis intermediate point Pmh and a black display was performed in the other regions (“major axis intermediate”) as shown in FIG. 8, and the case where a white display was performed only in the region 21 including the diagonal axis intermediate point Pmd and a black display was performed in the other regions (“diagonal axis intermediate”) as shown in FIG. 9. FIG. 6 shows the results.

In FIG. 6, when the thickness ratio Tmv/Tv is decreased, the sagging amount ZPmv at the minor axis intermediate point Pmv of the inner surface of the panel 3 shown in FIG. 2 decreases, and the sagging amount ZMmv at the minor axis intermediate point Mmv of the shadow mask 7 shown in FIG. 3 also decreases. Therefore, in the shadow mask 7, the difference between the sagging amount ZMmv at the minor axis intermediate point Mmv and the sagging amount ZMmh at the major axis intermediate point Mmh decreases, and the radius of curvature at the major axis intermediate point Mmh increases. Consequently, in the case of performing a white display only in the region 20 including the major axis intermediate point Pmh as shown in FIG. 8, the beam movement amount increases.

In contrast, when the thickness ratio Tmv/Tv is increased, the sagging amount ZPmv at the minor axis intermediate point Pmv of the inner surface of the panel 3 shown in FIG. 2 increases, and the sagging amount ZMmv at the minor axis intermediate point Mmv of the shadow mask 7 shown in FIG. 3 also increases. Therefore, in the shadow mask 7, the difference between the sagging amount ZMmv at the minor axis intermediate point Mmv and the sagging amount ZMmh at the major axis intermediate point Mmh increases, and the radius of curvature at the major axis intermediate point Mmh decreases. Consequently, in the case of performing a white display only in the region 20 including the major axis intermediate point Pmh as shown in FIG. 8, the beam movement amount decreases.

Furthermore, when the thickness ratio Tmv/Tv is increased, the sagging amount ZPmv at the minor axis intermediate point Pmv of the inner surface of the panel 3 shown in FIG. 2 increases, and the sagging amount ZMmv at the minor axis intermediate point Mmv of the shadow mask 7 shown in FIG. 3 also increases. Therefore, in the shadow mask 7, the difference between the sagging amount ZMmv at the minor axis intermediate point Mmv and the sagging amount ZMmd at the diagonal axis intermediate point Mmd decreases, and the radius of curvature at the diagonal axis intermediate point Mmd increases. Consequently, in the case of performing a white display only in the region 21 including the diagonal axis intermediate point Pmd as shown in FIG. 9, the beam movement amount increases.

In contrast, when the thickness ratio Tmv/Tv is decreased, the sagging amount ZPmv at the minor axis intermediate point Pmv of the inner surface of the panel 3 shown in FIG. 2 decreases, and the sagging amount ZMmv at the minor axis intermediate point Mmv of the shadow mask 7 shown in FIG. 3 also decreases. Therefore, in the shadow mask 7, the difference between the sagging amount ZMmv at the minor axis intermediate point Mmv and the sagging amount ZMmd at the diagonal axis intermediate point Mmd increases, and the radius of curvature at the diagonal axis intermediate point Mmd decreases. Consequently, in the case of performing a white display only in the region 21 including the diagonal axis intermediate point Pmd as shown in FIG. 9, the beam movement amount decreases.

From FIG. 6, in the case of satisfying 0.6≦Tmv/Tv≦0.7, the beam movement amount becomes 200 μm or less, which generally is considered not to cause a problem of visibility. Furthermore, in the case where it is necessary to reduce the beam movement amount, the thickness Td of the panel 3 at the diagonal axis end Pd and the thickness Th of the panel 3 at the major axis end Ph may be increased.

It is preferable to apply a coating such as tungsten oxide to the surface of the shadow mask 7 of the color picture tube according to the present invention, because doming can be suppressed further.

In the color picture tube according to the present invention, color displacement caused by doming is reduced in spite of the fact that the panel outer surface is substantially flat so as to enhance the visibility, and the material for the shadow mask contains iron as a main component so as to suppress the cost. Thus, the present invention can be used widely as a color picture tube capable of performing a satisfactory color display at low cost.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color picture tube, comprising: a panel with a substantially rectangular phosphor screen formed on an inner surface; a funnel connected to the panel; a shadow mask opposed to the phosphor screen; and an electron gun provided in a neck of the funnel,
wherein a radius of curvature of an arc passing through three points on an outer surface of the panel, which respectively correspond to a pair of diagonal axis ends on one diagonal axis of the phosphor screen and a center of the phosphor screen, is 10,000 mm or more,
the shadow mask is made of an aluminum killed material, and
assuming that a thickness of the panel is Td at the diagonal axis end of the phosphor screen, Tmd at an intermediate point between the diagonal axis end and the center, Th at a major axis end of the phosphor screen, and Tmh at an intermediate point between the major axis end and the center, 0.5≦Tmd/Td≦0.62, and 0.65≦Tmh/Th≦0.80 are satisfied.

2. The color picture tube according to claim 1, wherein assuming that a thickness of the panel is Tv at a minor axis end of the phosphor screen, and Tmv at an intermediate point between the minor axis end and the center, 0.6≦Tmv/Tv≦0.7 is satisfied.
